(19) United States
(12) Patent Application Publication
(10) Pub. No.: US 2011/0239613 A1
(43) Pub. Date: Oct. 6, 2011

(54) LAWNMOWER

(75) Inventors: Masahiro Isono, Hitachinaka-shi (JP); Hiroshi Yamaguchi, Hitachinaka-shi (JP); Ai Nakayama, Hitachinaka-shi (JP)

(73) Assignee: HITACHI KOKI CO., LTD.

(21) Appl. No.: 13/075,939

(22) Filed: Mar. 30, 2011

(30) Foreign Application Priority Data
Mar. 31, 2010 (JP) 2010-084027

(51) Int. Cl. A01D 43/06; A01D 34/52

(52) U.S. Cl. 56/202; 56/255

(57) ABSTRACT

A lawnmower comprises a chassis having wheels (front wheels, a rear wheel) and capable of moving at least in a predetermined forward direction; a motor provided on the chassis, having a rotor, a stator and an output shaft and positioned with the axial line of the output shaft substantially vertical; a rotary blade connected to the output shaft; a handle arranged separated from the chassis; and a connecting piece (retractable pipes) connecting the chassis and the handle. The rotor comprises coil disks that have a plurality of annular coils arranged in a circumferential direction about the output shaft as viewed from the direction of the axial line of the output shaft. The stator comprises a magnetic flux generation mechanism that generates magnetic flux passing through the coil disks in the direction of the axial line of the output shaft.

### CROSS-REFERENCE TO RELATED APPLICATION

This application claims the benefit of Japanese Patent Application No. 2010-084027, filed Mar. 31, 2010, the entire disclosure of which is incorporated by reference herein.

### FIELD

This application relates generally to a lawnmower powered by a motor.

### BACKGROUND

In the past, a lawnmower has been known that is provided with a motor attached to a chassis having wheels, a rotary blade driven by the motor, a handle provided so as to separate upward and to the rear from the chassis, a connecting piece connecting the chassis and the handle and a grass collection case into which grass cut by the rotary blade is collected. Such a lawnmower is disclosed for example in Unexamined Japanese Patent Application KOKAI Publication No. 2009-219428 and Unexamined Japanese Patent Application KOKAI Publication No. 2004-159621. In the lawnmower disclosed in Unexamined Japanese Patent Application KOKAI Publication No. 2009-219428, the grass collection case is positioned to the rear of the chassis. In the lawnmower disclosed in Unexamined Japanese Patent Application KOKAI Publication No. 2004-159621, the grass collection case is attached to a connecting piece and is arranged lengthily in the up-and-down direction.

From the perspectives of operability, transportability and storability, it is desirable for the overall size of a lawnmower to be small. However, lawnmowers powered by motors typically have the rotary blade positioned such that the axis of rotation is vertical, with the output shaft of the motor also being positioned vertically. Consequently, there are limits to controlling the height of the chassis.

In addition, with a lawnmower in which the grass collection case is positioned to the rear of the chassis, such as the lawnmower disclosed in Unexamined Japanese Patent Application KOKAI Publication No. 2009-219428, the size in the front-to-back direction becomes large, causing poorer operability in narrow locations and places with obstacles. On the other hand, with a lawnmower in which the grass collection case is attached to a connecting piece and arranged lengthily in the up-and-down direction, such as the lawnmower disclosed in Unexamined Japanese Patent Application KOKAI Publication No. 2004-159621, the size in the front-to-back direction is relatively small. However, it is necessary to provide a route for the cut grass to be transported upward, and in addition operability is lost if the grass collection case or the route protrudes considerably to the rear of the connecting piece, so there are limits to the capacity of the grass collection case. In addition, if the grass collection case is arranged above the chassis, it is difficult to control the height of the chassis, so similarly it is difficult to enlarge the capacity of the grass collection case.

### SUMMARY

In consideration of the foregoing, it is an object of the present invention to provide a compact lawnmower.

In order to achieve the above and other objects, the lawnmower according to the present invention comprises:
a chassis having wheels and capable of moving at least in a predetermined forward direction;
a disc motor having disc-shaped coil discs, with the axial line of an output shaft being arranged substantially vertically;
a rotary blade connected to the output shaft;
a handle arranged separated from the chassis; and
a connecting piece connecting the chassis and the handle.

The above-described lawnmower may be comprised such that:
the disc motor has a rotor, a stator and the output shaft provided integrally and coaxially with the rotor;
one out of the rotor and the stator is provided with the coil discs; and
the other out of the rotor and the stator is provided with a magnetic flux generation mechanism for generating magnetic flux that passes through the coil disc in the axial direction of the output shaft.

The above-described lawnmower may further comprise:
a grass collection case positioned above the chassis; and
a fan connected to the output shaft, this fan generating a flow of air directed from near the rotary blade toward the inside of the grass collection case.

In addition, the grass collection case may be mounted on the chassis.

Furthermore, the grass collection case may be positioned in front of the connecting piece.

In addition, the coil discs may be composed of printed wiring boards on which a conductive pattern of a coil piece is formed.

Furthermore, the magnetic flux generation mechanism may be provided with a magnet.

With the present invention, it is possible to provide a compact lawnmower by suppressing the height of the chassis having the motor.

### BRIEF DESCRIPTION OF THE DRAWINGS

A more complete understanding of this application can be obtained when the following detailed description is considered in conjunction with the following drawings, in which:

FIG. 1 is the top view of a lawnmower according to a first embodiment of the present invention;

FIG. 2 is a cross-sectional view along line I-I in FIG. 1;

FIG. 3 is a cross-sectional view showing an enlargement of the chassis and the grass collection bag of FIG. 2;

FIG. 4 is a cross-sectional view showing an enlargement of the motor of FIG. 2;

FIG. 5 is a cross-sectional view showing the rotor and the output shaft of FIG. 4 disassembled;

FIG. 6 is a bottom view showing the semiconductor pattern of the coil/commutator disc shown in FIG. 5;

FIG. 7 is a bottom view showing the semiconductor pattern of the coil disc shown in FIG. 5;

FIG. 8 is a cross-sectional view showing a lawnmower according to a second embodiment of the present invention; and

FIG. 9 is a component cross-sectional view showing a variation on the motor shown in FIG. 4.

### DETAILED DESCRIPTION

The preferred embodiments of the present invention are described below with reference to the drawings.

### First Embodiment

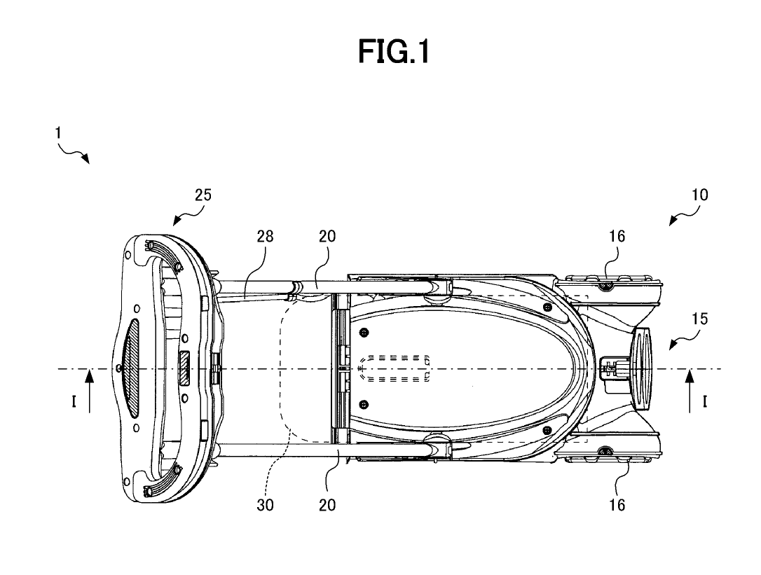

First, a lawnmower 1 according to a first embodiment will be described with reference to FIGS. 1 through 3. Unless explicitly stated, left and right in FIGS. 1 through 3 correspond to the front and rear, respectively, of the lawnmower 1. In addition, up and down in FIG. 1 correspond to the left and right, respectively, of the lawnmower 1.

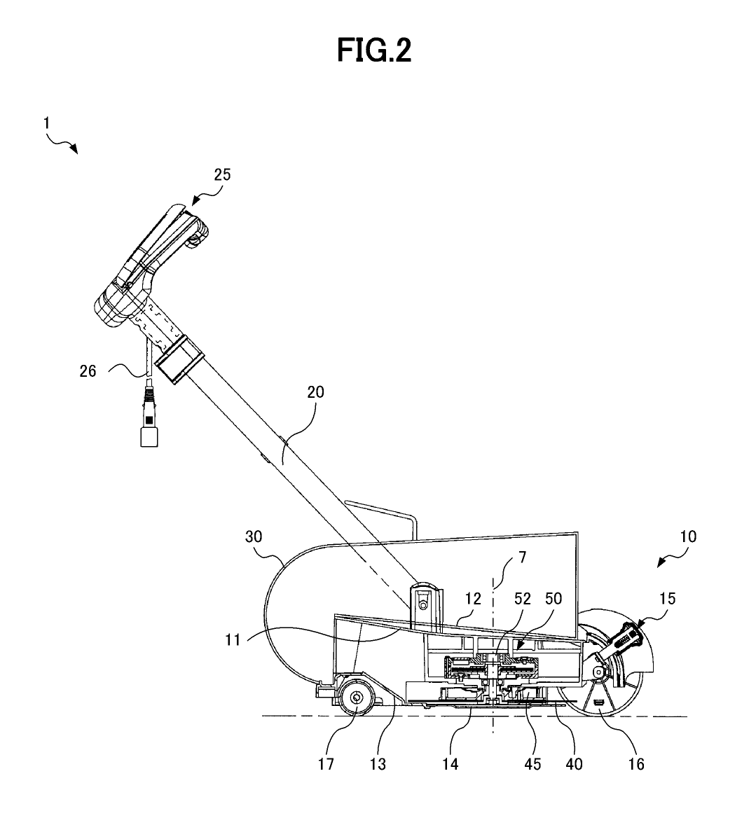

As shown in FIG. 1 and FIG. 2, the lawnmower 1 is provided with a chassis 10, a left and right pair of retractable pipes (connecting piece) 20 connected to the chassis, a handle 25 attached to the tips of the retractable pipes 20, and a grass collection bag (grass collection case) 30 mounted on the chassis 10.

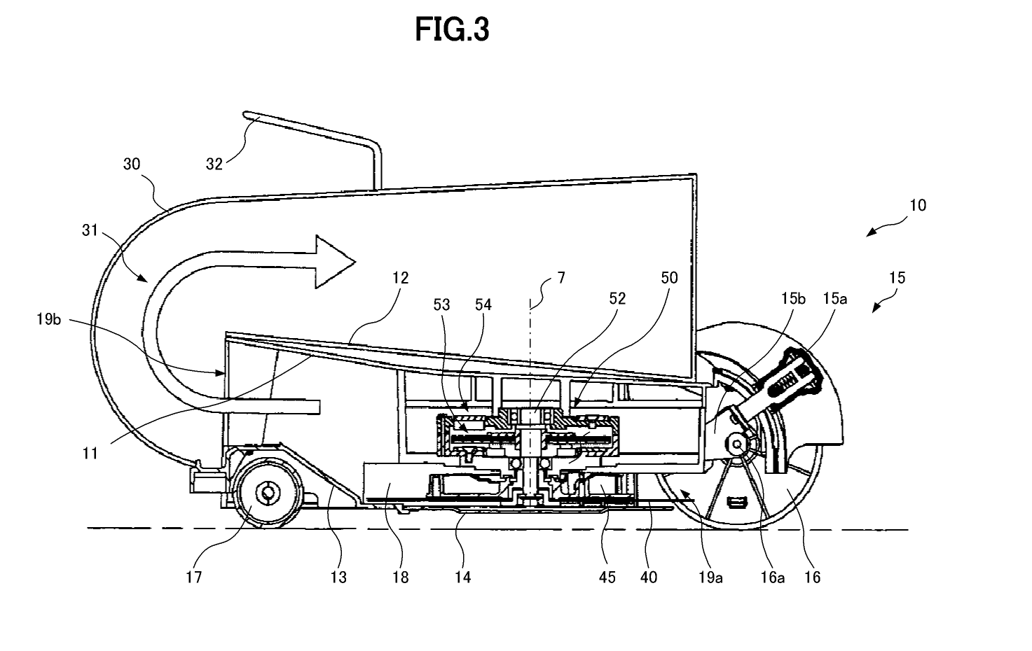

As shown in FIG. 3, the chassis 10 is primarily provided with a housing 11, a top cover 12 attached to the top of the housing 11, a bottom cover 13 attached to the bottom of the housing 11, a rotary blade protective cover 14 attached to the bottom of the housing 11, a left and right pair of front wheels 16, a rear wheel 17, a rotary blade 40 for cutting grass, a fan 45 for transmitting cut grass, a motor 50 that is the power source, and a height adjustment mechanism 15 for adjusting the height of the rotary blade 40 from the ground.

The housing 11 fixes the motor 50 such that a rotating shaft (axial line 7 of the output shaft 52) of the motor 50 is substantially vertical. The top cover 12 is attached to the top of the housing 11 so as to cover the motor 50 from above. The bottom cover 13 is attached to the bottom of the housing 11 below the rotary blade 40 attached to the output shaft 52 of the motor 50. The rotary blade protective cover 14 is attached to the housing 11 so as to cover the rotary blade 40 from below.

The housing 11 and the rotary blade protective cover 14 form a front opening 19a that opens toward the front of the chassis 10 so that the periphery to the front of the rotary blade 40 is exposed.

The housing 11 and the bottom cover 13 form a cut grass conveyance route 18 connecting to the front opening 19a, and a rear opening 19b that opens toward the rear of the chassis 10. The cut grass conveyance route 18 is formed up to the rear opening 19b with the route area enlarging toward the rear from near the rear edge of the rotary blade 40.

The front wheels 16 are supported at the front edge of the chassis 10 so as to be rotatable about a front axle 16a extending in the left-right direction. The front axle 16a is attached to the front edge of the housing 11 via the height adjustment mechanism 15.

The rear wheel 17 is composed of a roller with smaller diameter than the front wheels 16, and is attached to the rear edge of the chassis 10.

The rotary blade 40 and the fan 45 are attached to the output shaft 52 of the motor 50 and are housed between the housing 11 and the rotary blade protective cover 14 of the chassis 10. The rotary blade 40 can cut grass by means of multiple non-illustrated blades formed at the periphery thereof, by rotating under power from the motor 50. The fan 45 can create a flow of air directed toward the rear opening 19b along the cut grass conveyance route 18 from the front opening 19a of the chassis 10, by rotating under power from the motor 50.

The height adjustment mechanism 15 is composed of an arm 15a connecting the housing 11 and the front wheels 16a, and a lever 15b for adjusting the angle of the arm 15a. By sliding the lever 15b up or down, the relative height of the front wheels 16a and the housing 11 can be adjusted, and through this the height of the rotary blade 40 from the ground can be adjusted.

As shown in FIG. 2, the retractable pipes 20 are rotatably supported on the housing 11 between the front wheels 16 and the rear wheel 17 of the chassis 10, and can tilt in the front-to-back direction with respect to the chassis 10. The retractable pipes 20 are composed of two pipes interlocked so as to slide relative to each other. FIG. 2 shows the retracted stage, but the pipes can be extended when in use.

The handle 25 is attached to the tip of the retractable pipes 20. On the handle 25 are provided a power source cord 26 that can be connected to a commercial power source, a non-illustrated switch for turning on and off the motor 50, and a non-illustrated power source circuit for impressing a direct current voltage on the motor 50. The power source circuit and the motor 50 are connected by wiring 28 (see FIG. 1) arranged along the retractable pipes 20. The handle 25 can be tilted integrally with the retractable pipes 20, and when in use is arranged upward and to the rear of the chassis 10, as shown in FIG. 2.

As shown in FIG. 3, the grass collection bag 30 connects to the cut grass conveyance route 18 of the chassis 10 and also has a cut grass introduction route 31 bent toward the top of the chassis 10, and is connected so as to be removable from the rear opening 19b of the chassis along with being mounted on the chassis 10. A handle 32 is provided on the top surface of the grass collection bag 30.

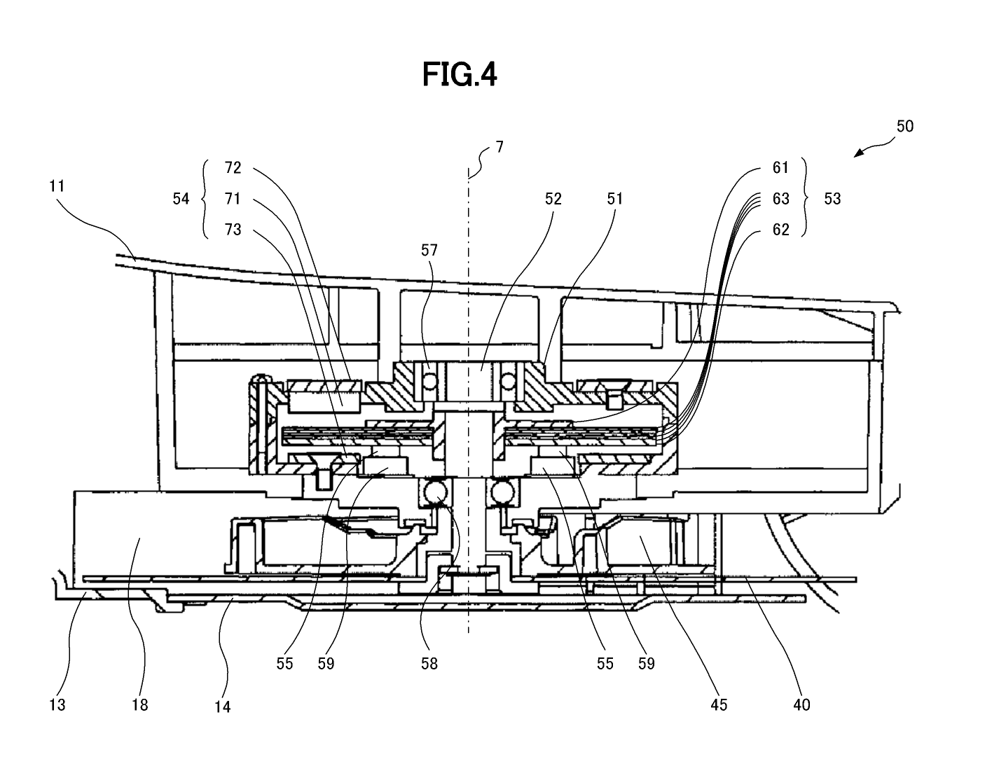

The motor 50 is composed as a commutator motor that receives electricity and outputs power to an output shaft 52, and as shown in FIG. 4, is composed of a motor housing 51 fixed to the housing 11, the output shaft 52, a rotor 53 that rotates integrally with output shaft 52, a stator 54 fixed to the motor housing 51, and a pair of brushes (sliders) 55 fixed to the motor housing 51.

The output shaft 52 is rotatably supported about the axial line 7 by a pair of bearings 57, 58 provided in the motor housing 51 and the housing 11. The rotary blade 40 and the fan 45 are attached to the output shaft 52, as described above.

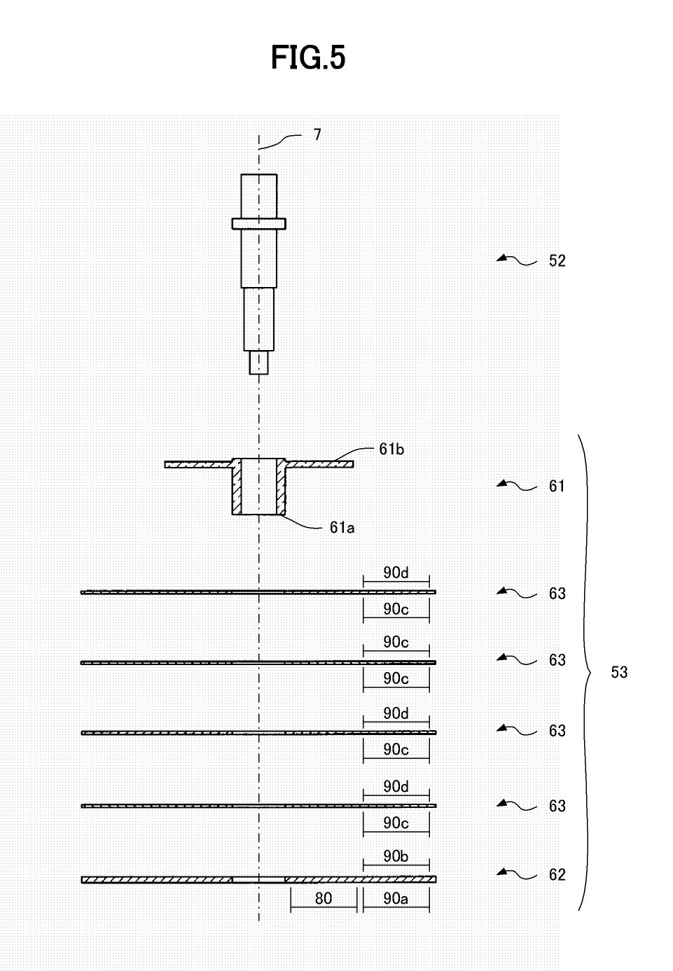

The rotor 53 is provided coaxially with the output shaft 52 and is formed in a disc shape centered on the axial line 7. As shown in FIG. 5, the rotor 53 is composed of a flange 61, a coil/commutator disc 62 and four coil discs 63.

The flange 61 is formed of, for example, an aluminum alloy, and has a cylindrical fixing member 61a around the axial line 7 and a discoid support member 61b protruding in a direction substantially perpendicular to the axial line 7 from the outer circumference surface of the fixing member 61a. The flange 61 has the fixing member 61a fixed to and engaged with the output shaft 52 so as not to rotate alone, and rotates together with the output shaft 52.

The coil/commutator disc 62 and the coil discs 63 are each a printed wiring board including an insulating substrate and a conductor pattern. The coil/commutator disc 62 and the coil discs 63 are each formed in a discoid shape having substantially same internal diameter and external diameter around the axial line 7, and are stacked together under the support member 61b of the flange 61 with the coil/commutator disc 62 being the outermost layer.

As shown in FIG. 5, provided on the bottom surface of the coil/commutator disc 62 are a commutator area 80 where a commutator conductor pattern is formed, and a coil area 90a where a coil conductor pattern is formed. The commutator area 80 and the coil area 90a are each provided as an annular area around the axial line 7, and the coil area 90a is arranged outwardly of the commutator area 80. Moreover, provided on the top surface of the coil/commutator disc 62 is a coil area 90b for forming a coil conductor pattern. The coil area 90b is provided as an annular area around the axial line 7, and is arranged so as to overlap the coil area 90a as viewed from the direction of the axial line 7.

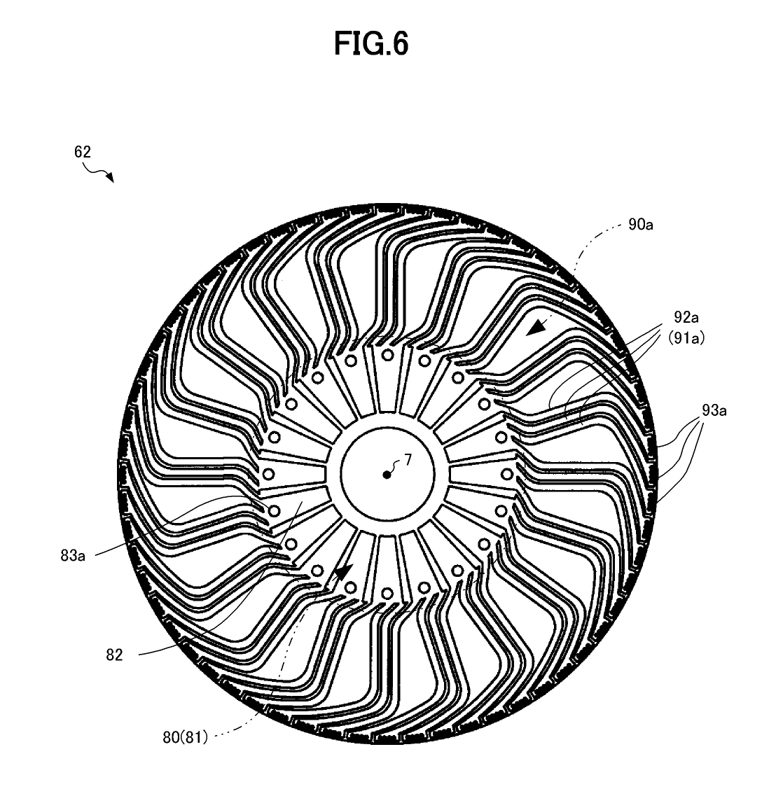

As shown in FIG. 6, the commutator area 80 on the bottom surface of the coil/commutator disc 62 has a commutator 81 formed by the conductor pattern. The commutator 81 comprises a plurality of commutator pieces 82 formed radially around the axial line 7. A through hole 83a that passes all the way through the coil/commutator disc 62 is formed in the outer end of each commutator piece 82.

The coil area 90a on the bottom surface of the coil/commutator disc 62 has a plurality of coil pieces 92a formed by the conductor pattern and formed radially around the axial line 7. Each coil piece 92a has an inner end directly connected to the corresponding commutator piece 82. Moreover, each coil piece 92a has an outer end bent in a predetermined direction around the axial line 7. A plurality of through holes 93a passing all the way through the coil/commutator disc 62 are formed in the outer end of each coil piece 92a.

The coil area 90b on the top surface of the coil/commutator disc 62 has a plurality of non-illustrated coil pieces formed by the conductor pattern similar to that of the coil area 90a shown in FIG. 6 and formed radially around the axial line 7. The outer end of each non-illustrated coil piece is connected to the corresponding coil piece 92a of the coil area 90 through a solder filled in the through holes 93a. Moreover, the inner end of each non-illustrated coil piece is connected to the corresponding commutator piece 82 of the commutator area 80 through a solder filled in the through hole 83a. Accordingly, the plurality of coil pieces 92a of the coil area 90a and the plurality of non-illustrated coil pieces of the coil area 90b form a plurality of coils 91a formed in a substantially annular shape (substantially rectangular shape with a side being omitted) as viewed from the direction of the axial line 7. The plurality of coils 91a are arranged in a circumferential direction around the axial line 7. The end of each coil 91a is connected to the corresponding commutator piece 82 of the commutator area 80.

As shown in FIG. 5, coil areas 90c, 90d where coil conductor patterns are formed are provided on the bottom surface and the top surface of the coil disc 63, respectively. The coil areas 90c, 90d are each formed in an annular shape around the axial line 7, and are arranged so as to overlap the coil areas 90a, 90b of the coil/commutator disc 62.

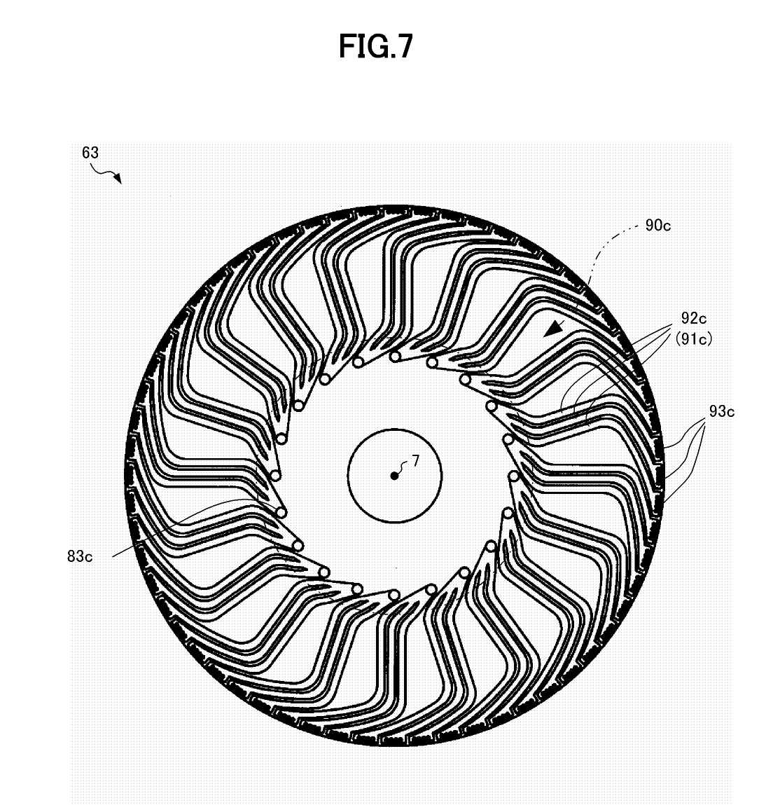

The coil areas 90c, 90d of the coil disc 63 have conductor patterns similar to those of the coil areas 90a, 90b of the coil/commutator disc 62. As shown in FIG. 7, the coil area 90c on the bottom surface of the coil disc 63 has a plurality of coil pieces 92c formed radially around the axial line 7. Moreover, the coil area 90d on the top surface of the coil disc 63 has a plurality of non-illustrated coil pieces formed by the similar conductor pattern to that of the coil area 90c. The plurality of coil pieces 92c of the coil area 90c and the plurality of non-illustrated coil pieces of the coil area 90d are respectively connected through solders filled in respective through holes 83c, 93c passing all the way through the coil disc 63, and form a plurality of coils 91c formed substantially in an annular (substantially rectangular shape with a side being omitted) as viewed from the direction of the axial line 7. The plurality of coils 91c is arranged in a circumferential direction around the axial line 7. The end of each coil 91c is connected to the corresponding commutator piece 82 through a solder filled in the through hole 83a of the coil/commutator disc 62.

Respective conductor patterns of the commutator area 80 and the coil area 90a of the coil/commutator disc 62 are formed on the same print wiring. Respective conductor patterns of the commutator area 80 and the coil area 90a of the coil/commutator disc 62 are formed so as to be thicker than that of the coil area 90b and those of the coil areas 90c, 90d of the coil disc 63 in order to suppress damage originating from friction with the brushes 55.

The coil/commutator disc 62 and the coil disc 63 are stacked together via a non-illustrated insulating layer in such a way that, for example, the coils 91a, 91c overlap as viewed from the direction of the axial line 7 or the coils 91a, 91c are arranged with a predetermined angle around the axial line 7.

As shown in FIG. 4, the stator 54 comprises a magnet 71 that is a permanent magnet, and a pair of yokes 72, 73. The magnet 71 is omitted from the drawings, but has a plurality of magnetic poles arranged in a circumferential direction around the axial line 7. The pair of yokes 72, 73 are each formed of a magnetic material like iron in an annular discoid shape, and are fixed to the motor housing 51. The yoke 72 is arranged so as to face the top surface of the rotor 53, more specifically, so as to face the coil area 90d (see FIG. 5) of the coil disc 63. The yoke 73 is arranged so as to face the bottom surface of the rotor 53, more specifically, so as to face the coil area 90a (see FIG. 5) of the coil/commutator disc 62. The magnet 71 is fixed to the bottom surface of the yoke 72 so as to face the bottom surface of the rotor 53. Accordingly, the pair of yokes 72, 73 form a magnetic path so that magnetic flux generated by the magnet 71 passes through the coil/commutator disc 62 and the coil disc 63 in the direction of the axial line 7. The magnet 71 and the yokes 72, 73 constitute a magnetic flux generation mechanism of the present invention.

The pair of brushes 55 are held by a pair of brush holders 59 fixed to the motor housing 51 so as to slidingly contact the bottom surface of the rotor 53, more specifically, so as to slidingly contact the pair of commutator pieces 82 of the coil/commutator disc 62 (see FIG. 6), and are arranged across the axial line 7. The brushes 55 are energized toward the bottom surface of the rotor 53 by an energizing mechanism such as a non-illustrated spring provided at the brush holders 59. The brush 55 is formed of a carbon with an electrical conductivity, and is connected to a non-illustrated power-source circuit provided on the above-explained handle 25 via the above-explained wiring 28 (see FIG. 1).

According to the lawnmower 1 having the above-explained structure, as the non-illustrated switch provided in the handle 25 is actuated, a predetermined voltage is applied to the brushes 55 of the motor 50 from the non-illustrated power-source circuit. The voltage applied to the brushes 55 is applied to the coils 91a, 91c of the rotor 53 through the commutator 81. Thereafter, the coils 91a, 91c of the rotor 53 form magnetic flux in the direction of the axial line 7 by the stator 54 as explained above, a current starts flowing in the direction vertical to the magnetic flux and perpendicular to the axial line 7 by the voltage applied through the commutator 81, and rotational force is generated at the rotor 53 around the axial line 7. Accordingly, the rotor 53, the output shaft 52 fixed to the rotor 53, and the rotary blade 40 and the fan 45 attached to the output shaft 52 rotate together with the axial line 7 being a rotational axis.

Next, when the handle 25 is pressed forward, the lawnmower 1 moves forward accompanying rotation of the front wheels 16 and the rear wheel 17 of the chassis 10. At this time, the rotary blade 40 moves while cutting the lawn on the route to a roughly uniform height. In addition, the fan 45 creates a flow of air directed from the front opening 19a of the chassis toward the rear opening 19b along the cut grass conveyance route 18, and grass cut by the rotary blade 40 is conveyed into the grass collection bag 30.

The above-explained motor 50 with the foregoing structure comprises the rotor 53 including the discoid coil/commutator disc 62 and coil disc 63 having the coils 91a, 91c arranged in the circumferential direction around the axial line 7 of the output shaft 52, and the stator 54 including the magnetic flux generation mechanism (magnet 71 and the yokes 72, 73) which generates magnetic flux passing through the coil/commutator disc 62 and the coil disc 63 in the direction of the axial line 7. Accordingly, in comparison with the motor of a conventional lawnmower, the lawnmower has a flat, compact shape with the width in the direction of the axial line 7 of the output shaft 52 suppressed.

Moreover, the coil/commutator disc 62 and the coil disc 63 configuring the rotor 53 of the motor 50 each comprise a printed wiring board where the conductor pattern of the coil 91a or 91c is formed. Accordingly, in comparison with a motor having a coil wound around a core formed of a magnetic material like iron, the rotor 53 is light-weight, so that the motor 50 is light-weight and is quick to actuate. Moreover, because the rotor 53 has no so-called coil end (a bent portion out of a core in a coil wound around the core), the motor 50 can be further flat and compact in size, and heat generation by the coils 91a, 91c can be suppressed. Furthermore, because the surface area of the rotor 53, i.e., the heat dissipation area, is large, the motor 50 has a good cooling efficiency for the coils 91a, 91c. Therefore, output declines in the motor 50 caused by overheating of the coils 91a and 91c can be suppressed.

As explained above, with the lawnmower 1 having the above-explained composition, by utilizing the above-described flat, compact motor 50, it is possible to suppress the height of the chassis 10.

Accordingly, by arranging the grass collection bag 30 above the chassis 10, it is possible to suppress the length of the lawnmower 1 in the front-to-back direction and to enlarge the capacity of the grass collection bag 30 while suppressing the height of the lawnmower 1. By suppressing the length of the lawnmower 1 in the front-to-back direction, it is possible to improve operability in spaces with obstacles and in tight spaces and to improve transportability and storability. Furthermore, by mounting the grass collection bag 30 on the chassis 10, it is possible to stabilize and support the grass collection bag 30, and it is also possible to further enlarge the capacity of the grass collection bag 30. Moreover, by enlarging the capacity of the grass collection bag 30, it is possible to improve operations by reducing the frequency of dumping grass collected in the grass collection bag 30.

### Embodiment 2

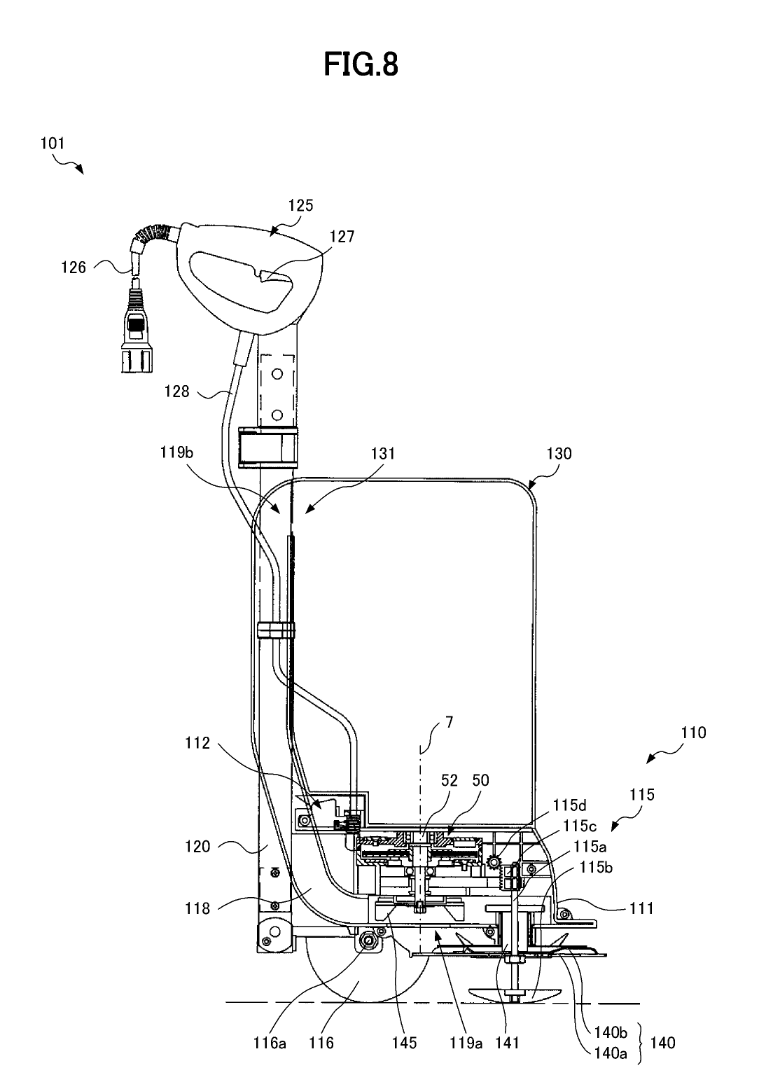

Next, a lawnmower 101 according to a second embodiment will be described with reference to FIG. 8. Here, compositions in common with the lawnmower 1 according to the first embodiment are labeled with same symbols and explanation of such is omitted. Unless otherwise stated, the right and left directions in FIG. 8 correspond to the front and back directions, respectively, of the lawnmower 101.

The lawnmower 101 includes a chassis 110, a left and right pair of retractable pipes 120 connected to the chassis 110, a handle 125 positioned at the tip of the retractable pipes 120, and a grass collection bag (grass collection case) 130 mounted on the chassis 110.

The chassis 110 primarily comprises a housing 111, a left and right pair of wheels 116, a blade 140, a fan 145, the motor 50 shown in the first embodiment, and a height adjustment mechanism 115.

The housing 111 is composed of a plurality of cases and covers and houses the motor 50 so that the rotary axis (axial line 7 of the output shaft) is substantially vertical. In addition, the housing 111 houses a fan 145 attached to the output shaft 52 of the motor 50.

In the housing 111, a lower opening 119a facing the bottom of the chassis 10 is formed below the fan 145. In addition, in the housing 111 a cut grass conveyance route 118 is formed extending upward from near the fan 145. Furthermore, in the housing 111 a top opening 119b facing the front of the chassis 110 is formed in the top edge of the cut grass conveyance route 118.

The front wheels 116 are supported so as to be rotatable about an axle 116a extending in the left-right direction.

The blade 140 is positioned to the front of the axial line 7 and comprises a fixed blade 140a and a rotary blade 140b mutually overlapping in the vertical direction. The fixed blade 140a is formed in a substantially discoid shape having a plurality of non-illustrated blades arranged on one part of the perimeter, and is attached to the lower part of the housing 111 so that the plurality of blades face the front and are substantially parallel with the ground. The rotary blade 140b has an outer diameter substantially same as the perimeter of the fixed blade 140a, is formed in a discoid shape having a non-illustrated plurality of blades arranged at the perimeter, and is connected to the output shaft 52 of the motor 50 via a non-illustrated plurality of gears. The blade 140 can cut grass interposed between the respective blades of the fixed blade 140a and the rotary blade 140b that receives power from the motor and rotates, accompanying the relative rotation of these.

The fan can create a flow of air from the lower opening 119a of the housing, through the cut grass conveyance route 18 and toward the top opening 119b by receiving power from the motor and rotating.

The height adjustment mechanism 115 comprises a rod 115a supported on the housing 111 so as to be slideable in the up-and-down direction, a ground-contact member 115b provided at the bottom edge of the rod 115a, a rack 115c provided on the top edge of the rod 115a, and a pinion 115d rotatably supported on the housing 111 and enmeshing with the rack 115c. The relative heights of the ground-contact member 115b and the blade 140 can be adjusted by causing the pinion 115d to rotate from the outside, and accordingly the height of the blade 140 from the ground can be adjusted. The rod 115a passes through a cylindrical bearing 141 connected to the rotary blade 140b and is positioned coaxially with the blade 140.

The retractable pipes 120 are rotatably supported on the housing 111 at the back edge of the chassis 110 and can tilt in the front-to-back direction with respect to the chassis 110. During transport and storage, the retractable pipes 120 can be shortened in length and also arranged substantially vertically, as shown in FIG. 8.

A handle 125 is attached to the tip of the retractable pipes 120. The handle 125 is provided with a power-source cord 126, a switch 127 for starting and stopping the motor 50, and a non-illustrated power-source circuit for applying a direct-current voltage to the motor 50. The power-source circuit and the motor 50 are connected by wiring 128.

The grass collection bag 130 has a cut grass guide member 131 connecting to the cut grass conveyance route 118 of the chassis 110, and is mounted on the chassis 110 along with being connected to the front opening 119b of the chassis 110. With suppressed thickness in the front-to-back direction and the elongated form in the top-to-bottom direction, the grass collection bag 130, unlike in the first embodiment, is arranged to the front of the retractable pipes 120 without protruding to the rear of the retractable pipes 120 even in the state in which the retractable pipes 120 are positioned substantially vertically. Furthermore, the grass collection bag 130 does not protrude to the front or back of the chassis 110, nor protrude upward from the handle 125. Accordingly, the lawnmower 1 can easily be made compact for transport and storage. In addition, the grass collection bag 130 can be attached by interlocking with a latch 112 provided on the top surface of the chassis 110, and is composed so as to be removable from above.

With the lawnmower 101 according to second embodiment as thus comprised, when the switch 127 provided on the handle 125 is actuated, a predetermined direct-current voltage is applied to the motor 50 from a non-illustrated power-source circuit, and the output shaft 52 of the motor, the fan 145 attached to the output shaft 52, and the rotary blade 140b connected to the output shaft 52 via a non-illustrated reduction gear mechanism rotate.

Next, when the handle 125 is pressed forward, the lawnmower 101 moves forward accompanying rotation of the wheels 116 of the chassis 110. At this time, the blade 140 moves while cutting the grass on the route to a substantially uniform height. In addition, the fan 145 generates a flow of air from the bottom opening 119a of the chassis, along the cut grass conveyance route 118 toward the top opening 119b, so that grass cut by the blade 140 is conveyed into the grass collection bag 130.

With the lawnmower 101 having the above-explained composition, it is possible to suppress the height of the chassis 110 similar to the lawnmower 1 according to the first embodiment by utilizing the above-described flat, compact motor 50.

Accordingly, by arranging the grass collection bag 130 above the chassis 110, it is possible to enlarge the capacity of the grass collection bag 130 and suppress the length of the lawnmower 101 in the front-to-back direction while suppressing the height of the lawnmower 101, similar to the lawnmower 1 according to the first embodiment.

Furthermore, by mounting the grass collection bag 130 on the chassis 110, the grass collection bag 130 can be stabilized and supported, and moreover it is possible to further enlarge the capacity of the grass collection bag 130. In addition, the grass collection bag 130 can be easily attached and removed because the bag is attached to a latch 112 provided on the top surface of the chassis 110.

In addition, by positioning the grass collection bag 130 to the front of the retractable pipes 20 so as to not protrude to the rear from the retractable pipes 120, it is possible to further suppress the overall size of the lawnmower 101 while maintaining the capacity of the grass collection bag 30.

### Variation

The present invention is not limited to the above-described embodiments, for various variations that fall within the scope of the Claims are also included in the technological scope of the present invention.

For example, the shape of the coils formed on the coil disc according to the present invention and the positioning of the electrodes in the magnetic flux generation mechanism according to the present invention can be arbitrarily changed as long as a commutator motor can be comprised.

In addition, the magnetic flux generation mechanism according to the present invention is not limited to one composed of a magnet, and may, for example, be composed of a coil so long as magnetic flux is generated that passes through the coil disc in the direction of the axial line of the output shaft of the motor.

In addition, the lawnmowers 1 and 101 of the first and second embodiments each have a motor 50 that is a commutator motor composed of a rotor 53 having a coil/commutator disc 62 and a coil disc 63, and a stator 54 having a magnetic flux generation mechanism (a magnet 71 and yokes 72, 73), but the lawnmower according to the present invention is not limited to this, for example, for the device may be equipped with a brushless motor composed of a rotor having a magnet and a stator having a coil disc.

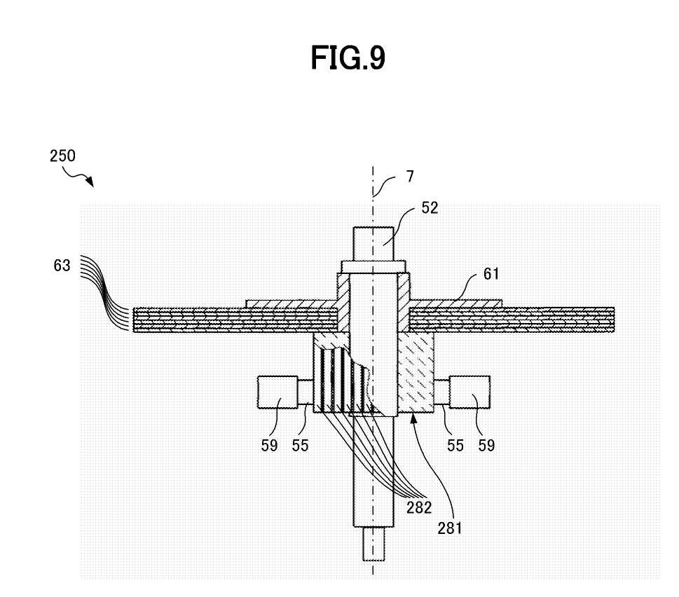

In addition, the motor 50 of the first and second embodiments is equipped with a commutator 81 formed by a conductive pattern on the bottom surface of the coil/commutator disc 62, but the motor according to the present invention is not limited to this, for a cylindrical commutator 281 positioned on the bottom surface of the coil disc 63 may be provided for example, as in the motor 250 shown in FIG. 9. The commutator 281 of the motor 250 is composed of multiple commutator pieces 282 arranged in the circumferential direction centered on the axial line 7, and each commutator piece 282 is formed through mechanical processing and is electrically connected to the corresponding coil 91c of the coil disc 63. In addition, the pair of brushes 55 is positioned so as to slidingly contact the outer perimeter surface of the commutator 281 from a direction substantially perpendicular to the axial line 7. In the motor 250 of this variation, the brushes 55 slidingly contact the outer perimeter surface of the commutator 81 from a direction substantially perpendicular to the axial line 7, so surface shaking is less likely to occur accompanying warping of the rotor 54 or the force received from the brushes 55, and rotation of the rotor 54 and the contact between the rotor 54 and the brushes 55 is stable in comparison to arrangements in which the brushes 55 contact the commutator 81 in the direction along the axial line 7. In addition, the commutator pieces 282 formed through mechanical processing or the like can easily be formed more thickly in comparison to commutator pieces 82 formed through conductive patterns, so damage from friction with the brushes 55 can be suppressed. Furthermore, the brushes 55 are positioned so as to extend in a direction substantially perpendicular to the axial line 7, so it is possible to suppress the effect of the length of the brushes 55 on the height of the lawnmower. Through this, by making the length of the brushes 55 larger than the length of the commutator 281 in the direction of the axial line 7, it is possible to compose a brush 55 with a longer life while reducing the height of the lawnmower. Accordingly, with the motor 250 having the above-described composition, it is possible to more easily realize a highly efficient, long-lasting motor 250 while suppressing the height of the motor 250, in comparison to the motor 50 of the first and second embodiments.

In addition, the coil/commutator disc 62 and the coil discs 63 according to the embodiments are composed of printed wiring boards, but the coil disc according to the present invention is not limited to this and may, for example, be composed of multiple thin coils or the like arranged in a disc shape.

In addition, the grass collection bag (grass collection case) 30, 130 of the embodiments are mounted on the chassis 10, 110, but the grass collection case according to the present invention is not limited to this, for the bag may be provided on the connection piece of the retractable pipes so as to be positioned about the chassis. In this manner, the heights of the motor and the chassis are suppressed, so it is easy to enlarge the capacity of the grass collection case.

In addition, the compositions shown in the above-described embodiments and variation may be combined.

The materials, shapes, numbers and positioning of various compositions may be appropriated changed within the scope of achieving the object of the present invention.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A lawnmower comprising:
a chassis having wheels and capable of moving at least in a predetermined forward direction;
a disc motor having disc-shaped coil discs, with the axial line of an output shaft being arranged substantially vertically;
a rotary blade connected to the output shaft;
a handle arranged separated from the chassis; and
a connecting piece connecting the chassis and the handle.

2. The lawnmower according to claim 1, wherein:
the disc motor has a rotor, a stator and the output shaft provided integrally and coaxially with the rotor;
one out of the rotor and the stator is provided with the coil discs; and
the other out of the rotor and the stator is provided with a magnetic flux generation mechanism for generating magnetic flux that passes through the coil disc in the axial direction of the output shaft.

3. The lawnmower according to claim 1, further comprising:
a grass collection case positioned above the chassis; and
a fan connected to the output shaft, said fan generating a flow of air directed from near the rotary blade toward the inside of the grass collection case.

4. The lawnmower according to claim 3, wherein the grass collection case is mounted on the chassis.

5. The lawnmower according to claim 3, wherein the grass collection case is positioned in front of the connecting piece.

6. The lawnmower according to claim 2, wherein the coil discs are composed of printed wiring boards on which a conductive pattern of a coil piece is formed.

7. The lawnmower according to claim 2, wherein the magnetic flux generation mechanism is provided with a magnet.
